(19) United States
(12) Patent Application Publication
(10) Pub. No.: US 2025/0307060 A1
(43) Pub. Date: Oct. 2, 2025

(54) METHOD AND DEVICE OF PREDICTING A FAILURE OF A STORAGE DEVICE

(71) Applicant: SAMSUNG ELECTRONICS CO., LTD., SUWON-SI (KR)

(72) Inventors: Tianyi ZHANG, SUWON-SI (KR); Yuqi ZHANG, SUWON-SI (KR)

(21) Appl. No.: 18/890,089

(22) Filed: Sep. 19, 2024

(30) Foreign Application Priority Data
Mar. 28, 2024 (CN) 202410373794.X

(51) Int. Cl. G06F 11/07

(52) U.S. Cl. CPC G06F 11/079; G06F 11/0727; G06F 2201/805

(57) ABSTRACT

A method for predicting a failure of a storage device includes: determining a matrix of differences between actual values of a plurality of attributes of the storage device obtained during a time period and predicted values of the plurality of attributes of the storage device for the time period; and predicting whether the storage device will fail based on the matrix of differences.

### CROSS-REFERENCE TO RELATED APPLICATION(S)

This patent application claims priority under 35 U.S.C. § 119 to Chinese Patent Application No. 202410373794.X filed on Mar. 28, 2024, in the Chinese Intellectual Property Office, the disclosure of which is incorporated by reference in its entirety herein.

### 1. Technical Field

The present disclosure relates to data storage, and more specifically, to a method and device for predicting a failure of a storage device.

### 2. Discussion of Related Art

Failures of a storage device (e.g., a Solid State Drive (SSD)) may be predicted using a machine learning-based binary classification method or an anomaly detection method. However, these methods do not consider to mutations in attributes and fine-grained failure symptoms.

The machine learning-based binary classification method uses a model trained from data of storage devices in which particular failures have occurred. Thus, the trained model has a difficult time predicting a failure based on factors different from those that occurred during those particular failures.

The machine learning-based anomaly detection method identifies unusual patterns or outliers in data that do not conform to expected behavior. However, this method cannot accurately predict failure modes of storage devices in which failures occurred.

Further, some existing methods for predicting a failure of a storage device only predict whether a failure of the storage device will occur, but cannot predict the severity of the failure of the storage device that will occur.

Thus, there is a need for methods and devices for predicting a failure of a storage device that considers mutations in the attributes of the storage device.

### SUMMARY

At least one embodiment of the present disclosure provides a method and device for predicting a failure of the storage device at a finer granularity by considering mutations in attributes of the storage device.

According to an aspect of embodiments of the present disclosure, there is provided a method of predicting a failure of a storage device including: determining a matrix of differences between actual values of a plurality of attributes of the storage device obtained during a first time period and predicted values of the plurality of attributes of the storage device for the first time period; and predicting whether the storage device will fail based on the matrix of differences.

According to embodiments of the present disclosure, the accuracy of predicting the failure of the storage device may be increased by predicting the failure of the storage device by considering mutations in the attributes of the storage device.

According to some embodiments of the present disclosure, the predicting of whether the storage device will fail based on the matrix of differences may include: predicting whether the storage device will fail based on a first similarity between the matrix of differences and first matrices of differences for a plurality of healthy storage devices and a second similarity between the matrix of differences and second matrices of differences for a plurality of failed storage devices. The first matrices of differences for the plurality of healthy devices may include a matrix of differences between actual values of the plurality of attributes of each of the healthy storage devices obtained during a time period with a first duration and predicted values of the plurality of attributes of each of the healthy storage devices for the time period with the first duration. The second matrices of differences for the plurality of failed devices may include a second matrix of differences between actual values of the plurality of attributes of each of the failed storage devices for the time period with the first duration before each failed storage device failed and predicted values of the plurality of attributes of each of the failed storage devices for the time period with the first duration before each failed storage device failed. The first duration may be the same as a duration of the first time period.

According to some embodiments of the present disclosure, the predicting of whether the storage device will fail based on the matrix of differences may include: determining that the storage device will not fail when the first similarity is greater than the second similarity; and determining that the storage device will fail when the first similarity is not greater than the second similarity.

According to some embodiments of the present disclosure, the first similarity may be indicative of a sum of distances between the matrix of differences and the first matrices of differences for the plurality of healthy storage devices, and the second similarity may be indicative of a sum of distances between the matrix of differences and the second matrices of differences for the plurality of failed storage devices.

According to some embodiments of the present disclosure, the method may further include: determining first distances between the matrix of differences and the first matrices of differences for the plurality of healthy storage devices based on a matrix of first weights for the attributes, the matrix of differences, and the first matrices of differences for the plurality of healthy storage devices; determining second distances between the matrix of differences and the second matrices of differences for the plurality of failed storage devices based on the a matrix of second weights for the attributes, the matrix of differences and the second matrices of differences for the plurality of failed storage devices. In an embodiment, the higher a frequency of occurrence of a mutation of an attribute in the healthy storage devices is, the greater a weight of the attribute in the matrix of weights for the attributes corresponding to the attribute is.

The determining of the first distances between the matrix of differences and the first matrices of differences for the plurality of healthy storage devices based on the matrix of first weights for the attributes, the matrix of difference and the first matrices of differences for the plurality of healthy storage devices may include: using a product of a difference between each element of the matrix of differences and a corresponding element of the first matrix of differences for each healthy storage device and a weight element corresponding to each element in the matrix of first weights for the attributes as a healthy weight difference corresponding to each element of the matrix of differences; and obtaining an arithmetic square root of the healthy weight differences corresponding to elements of the matrix of differences as a distance between the matrix of differences and the first matrix of difference for each healthy storage device. The determining of the second distances between the matrix of differences and the second matrices of differences for the plurality of failed storage devices based on the matrix of second weights for the attributes, the matrix of differences and the second matrices of differences for the plurality of failed storage devices may include: using a product of a difference between each element of the matrix of differences and a corresponding element of the second matrix of differences for each failed storage device and a weight element corresponding to each element in the matrix of second weights for the attributes as a failure weight difference corresponding to each element of the matrix of differences; and obtaining an arithmetic square root of the failure weight differences corresponding to elements of the matrix of differences as a distance between the matrix of differences and the second matrix of differences for each failed storage device.

According to embodiments of the present disclosure, the contribution of rare or infrequent mutations may be emphasized by applying weights to mutations of the attributes and thus failures that have not occurred can be predicted more accurately.

According to some embodiments of the present disclosure, the second similarity may include: a third similarity between the matrix of differences and matrices of differences for a plurality of failed storage devices having a first predetermined type of failure, and a fourth similarity between the matrix of differences and matrices of differences for a plurality of failed storage devices having a second predetermined type of failure.

According to some embodiments of the present disclosure, the predicting of whether the storage device will fail based on the first similarity and the second similarity may include: determining a minimum value of the first similarity, the third similarity, and the fourth similarity; determining that the storage device will not fail when the minimum value is the first similarity; and determining that the storage device will fail with the first predetermined type of failure when the minimum value is the third similarity; and determining that the storage device will fail with the second predetermined type of failure when the minimum value is the fourth similarity.

According to some embodiments of the present disclosure, the predicting of whether the storage device will fail based on the first similarity and the second similarity may include: determining that the storage device will not fail when the first similarity is greater than the second similarity and greater than a first threshold; determining that the storage device will fail with a first predetermined type of failure when the first similarity is greater than the second similarity and not greater than a first threshold; determining that the storage device will fail with a second predetermined type of failure when the first similarity is not greater than the second similarity and is greater than a second threshold; and determining that the storage device will fail with a third predetermined type of failure when the first similarity is not greater than the second similarity and is not greater than the second threshold.

According to some embodiments of the present disclosure, the method may further include: when determining that the storage device will fail with the second predetermined type of failure, analyzing the second predetermined type of failure based on at least one of: determining that the storage device will not fail when a similarity between the matrix of differences for the storage device and matrices of difference for other storage devices is less than a third threshold; and determining that the storage device will not fail when at least one of a temporal aggregation or a spatial aggregation of the second predetermined type of failures is present for a plurality of storage devices. The storage device and the other storage devices may be located together on a same server.

According to some embodiments of the present disclosure, the predicted values of the plurality of attributes for the first time period are determined based on actual values of the plurality of attributes of the storage device for a second time period by using a model, wherein the matrix of first weights and the matrix of second weights may be determined during a training phase of the model.

According to embodiments of the present disclosure, hierarchical prediction of failures of the storage device may be performed to determine the severity of a failure of the storage device that is likely to occur.

According to another aspect of embodiments of the present disclosure, there is provided a device for predicting a failure of a storage device, including: a first logic circuit (e.g., a determination unit) configured to determine a matrix of differences between actual values of a plurality of attributes of the storage device obtained during a first time period and predicted values of the plurality of attributes of the storage device for the first time period; and a second logic circuit (e.g., a prediction unit) configured to predict whether the storage device will fail based on the matrix of differences.

According to some embodiments of the present disclosure, the prediction unit may be configured to predict whether the storage device will fail based on a first similarity between the matrix of differences and a first matrices of differences for a plurality of healthy storage devices and a second similarity between the matrix of differences and second matrices of differences for a plurality of failed storage devices.

The first matrices of differences for the plurality of healthy devices may include a matrix of differences between actual values of the plurality of attributes of each of the healthy storage devices obtained during a time period with a first duration and predicted values of the plurality of attributes of each of the healthy storage devices for the time period with the first duration.

The second matrices of differences for the plurality of failed devices may include a matrix of differences between actual values of the plurality of attributes of each of the failed storage devices for the time period with the first duration before each failed storage device failed and predicted values of the plurality of attributes of each of the failed storage devices for the time period with the first duration before each failed storage device failed. The first duration may be the same as a duration of the first time period.

According to some embodiments of the present disclosure, the prediction unit may be configured to: determine that the storage device will not fail when the first similarity is greater than the second similarity; and determine that the storage device will fail when the first similarity is not greater than the second similarity.

According to some embodiments of the present disclosure, the first similarity may be indicative of a sum of distances between the matrix of differences and the first matrices of differences for the plurality of healthy storage devices, and the second similarity may be indicative of a sum of distances between the matrix of differences and the second matrices of differences for the plurality of failed storage devices.

According to some embodiments of the present disclosure, the prediction unit may be configured to: determine first distances between the matrix of differences and the first matrices of differences for the plurality of healthy storage devices based on a matrix of first weights for the attributes, the matrix of differences, and the first matrices of differences for the plurality of healthy storage devices; and determine second distances between the matrix of differences and the second matrices of differences for the plurality of failed storage devices based on a matrix of second weights for the attributes, the matrix of differences and the second matrices of differences for the plurality of failed storage devices. In an embodiment, the higher a frequency of occurrence of a mutation of an attribute in the healthy storage devices is, the greater a weight of the attribute in the matrix of weights for the attributes corresponding to the attribute is.

According to some embodiments of the present disclosure, the prediction unit may be configured to: use a product of a difference between each element of the matrix of differences and a corresponding element of the matrix of differences for each healthy storage device and a weight element corresponding to each element in the matrix of first weights for the attributes as a healthy weight difference corresponding to each element of the matrix of differences; obtain an arithmetic square root of the healthy weight differences corresponding to elements of the matrix of differences as a distance between the matrix of differences and the first matrix of differences for each healthy storage device; use a product of a difference between each element of the matrix of differences and a corresponding element of the second matrix of differences for each failed storage device and a weight element corresponding to each element in the matrix of second weights for the attributes as a failure weight difference corresponding to each element of the matrix of differences; and obtain an arithmetic square root of the failure weight differences corresponding to elements of the matrix of differences as a distance between the matrix of differences and the second matrix of differences for each failed storage device.

According to some embodiments of the present disclosure, the second similarity may include: a third similarity between the matrix of differences and matrices of differences for a plurality of failed storage devices having a first predetermined type of failure, and a fourth similarity between the matrix of differences and matrices of differences for a plurality of failed storage devices having a second predetermined type of failure.

According to some embodiments of the present disclosure, the prediction unit may be configured to determine a minimum value of the first similarity, the third similarity, and the fourth similarity; determine that the storage device will not fail when the minimum value is the first similarity; determine that the storage device will fail with the first predetermined type of failure when the minimum value is the third similarity; and determine that the storage device will fail with the second predetermined type of failure when the minimum value is the fourth similarity.

According to some embodiments of the present disclosure, the prediction unit may be configured to determine that the storage device will not fail when the first similarity is greater than the second similarity and greater than a first threshold; determine that the storage device will fail with a first predetermined type of failure when the first similarity is greater than the second similarity and not greater than a first threshold; determine that the storage device will fail with a second predetermined type of failure when the first similarity is not greater than the second similarity and is greater than a second threshold; and determine that the storage device will fail with a third predetermined type of failure when the first similarity is not greater than the second similarity and is not greater than the second threshold.

According to some embodiments of the present disclosure, the device further may include: an analysis unit (e.g., a third logic circuit), configured to, when determining that the storage device will fail with the second predetermined type of failure, analyze the second predetermined type of failure based on at least one of: determining that the storage device will not fail when a similarity between the matrix of differences for the storage device and matrices of difference for other storage devices is less than a third threshold; and determining that the storage device will not fail when a temporal and/or spatial aggregation of the second predetermined type of failures is present for a plurality of storage devices. The storage device may be located along with the other storage devices on a same server.

According to some embodiments of the present disclosure, the predicted values of the plurality of attributes for the first time period may be determined based on actual values of the plurality of attributes of the storage device for a second time period by using a model, wherein the matrix of first weights and the matrix of second weights are determined during a training phase of the model.

According to another aspect of embodiments of the present disclosure, there is provided an electronic device including: a memory configured to store one or more instructions; a plurality of storage devices; and a host processor configured to execute the one or more instructions to cause the host processor to perform the method of predicting a failure as described herein.

According to another aspect of embodiments of the present disclosure, there is provided a host storage system including a host, including a host memory and a host controller; and a storage device, wherein the host memory stores instructions that when executed by the host controller cause the host controller to perform the method of predicting a failure as described herein.

According to another aspect of embodiments of the present disclosure, there is provided a Universal Flash Storage (UFS) system including a UFS host configured to perform the method of predicting a failure as described herein; a UFS device; and a UFS interface for communicating between the UFS device and the UFS host.

According to another aspect of embodiments of the present disclosure, there is provided a storage system including: a memory device; and a memory controller configured to perform the method of predicting a failure as described herein.

According to another aspect of embodiments of the present disclosure, there is provided a data center system including a plurality of application servers; and a plurality of storage servers, wherein each of the plurality of application servers and/or each of the plurality of storage servers is configured to perform the method of predicting a failure as described herein.

According to another aspect of embodiments of the present disclosure, there is provided a computer readable storage medium storing a computer program that when executed by a processor causes the processor to implement the method of predicting a failure as described herein.

### BRIEF DESCRIPTION OF DRAWINGS

The above and other purposes and features of the present disclosure will become clearer through the following descriptions made in conjunction with the figures schematically illustrating the embodiments, in which:

FIG. 1 illustrates a schematic diagram of predicting a failure of a storage device based on a binary classification method according to a comparative embodiment;

FIG. 2 illustrates a flowchart of a machine learning model-based anomaly detection method according to a comparative embodiment;

FIG. 3 illustrates a flowchart of a method for predicting a failure of a storage device according to an embodiment of the present disclosure;

FIG. 4 illustrates a schematic diagram of determining a matrix of differences (or a matrix of mutations) and mutation rarity weights according to an embodiment of the present disclosure;

FIG. 5 illustrates a schematic diagram of an example of a method for predicting a failure of a storage device according to an embodiment of the present disclosure;

FIG. 6 illustrates a block diagram of a structure of a device for predicting a failure of a storage device according to an embodiment of the present disclosure;

FIG. 7 is a schematic diagram of an electronic device according to an embodiment of the present disclosure; and

FIG. 8 is a block diagram of a host storage system according to an embodiment of the present disclosure; and

FIG. 9 is a block diagram of a UFS system according to an embodiment of the present disclosure; and

FIG. 10 is a block diagram of a storage system according to an embodiment of the present disclosure; and

FIG. 11 is a schematic diagram of a data center to which storage devices are applied according to an embodiment of the present disclosure.

### DETAILED DESCRIPTION

Hereinafter, various embodiments of the present disclosure are described with reference to the accompanying drawings, in which like reference numerals are used to depict the same or similar elements, features, and structures. However, the present disclosure is not limited to the various embodiments described herein but it is intended that the present disclosure cover all modifications, equivalents, and/or alternatives within the scope of the present disclosure.

It is to be understood that the singular forms include plural forms, unless the context clearly dictates otherwise. The expressions “A or B,” or “at least one of A and/or B” may indicate A and B, A, or B. For instance, the expression “A or B” or “at least one of A and/or B” may indicate (1) A, (2) B, or (3) both A and B.

In various embodiments of the present disclosure, it is intended that when a component (for example, a first component) is referred to as being “coupled” or “connected” with/to another component (for example, a second component), the component may be directly connected to the other component or may be connected through another component (for example, a third component).

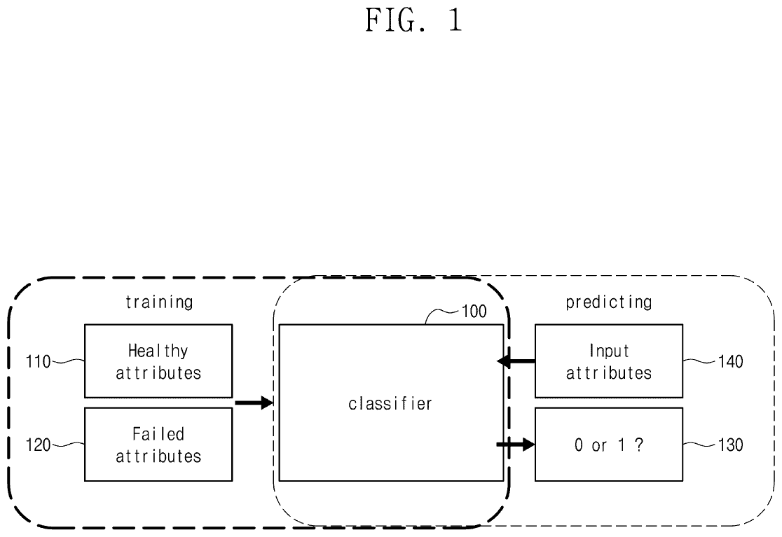

FIG. 1 illustrates a schematic diagram of predicting a failure of a storage device based on a binary classification method according to a comparative embodiment.

Referring to FIG. 1, a classifier 100 is trained by using attribute data of storage devices. The attribute data may include healthy attribute data 110 of healthy storage devices and failed attribute data 200 of failed storage devices. Then the classifier 100 calculates a result 130 based on based on input attribute data 140 that indicates whether a failure has occurred.

As can be seen from FIG. 1, the classifier 100 does not consider mutations of specific attributes. Since known failure data is used in training the classifier 100, the classifier 100 is only able to predict known failure modes, and is unable to accurately predict new modes of failure. Furthermore, when label data is not evenly distributed (e.g., the label data includes less data for failed storage devices), the classifier 100 performs poorly in terms of prediction accuracy.

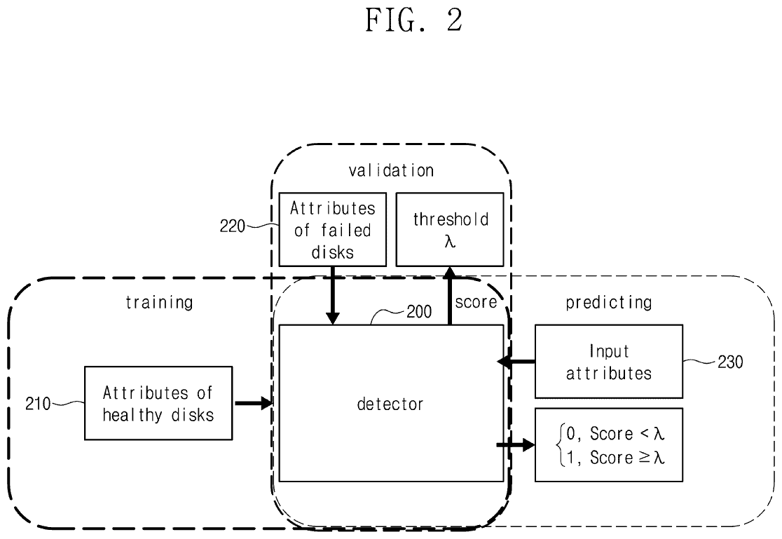

FIG. 2 illustrates a flowchart of a machine learning model-based anomaly detection method according to a comparative embodiment.

Referring to FIG. 2, a model (i.e., detector 200) is trained based on attribute information of healthy storage devices 210, and the detector 200 is then validated by using attribute information of failed storage devices 220 to determine a threshold value λ, and the trained detector 200 is then used to determine whether a storage device will fail based on an input of attribute information 230 of the storage device. Specifically, when the detector 200 obtains a score less than the threshold value λ, it is determined that the storage device will fail, and conversely, it is determined that the storage device will not fail.

Like the binary classification method, the anomaly detection method also does not consider mutations of specific attributes. The anomaly detection method does not learn patterns of the failed storage devices, and thus is unable to utilize all of the available real failure information, which hampers its ability to detect failure patterns. Further, when predicting failure based on time series data, the detector 200 (e.g., a Long Short-Term Memory (LSTM) model) relies heavily on step-by-step prediction, and thus the detector 200 has poor prediction performance for time sequential data that is too long and has large differences in length. Moreover, the anomaly detection is susceptible to noisy data and is not sufficiently robust and accurate.

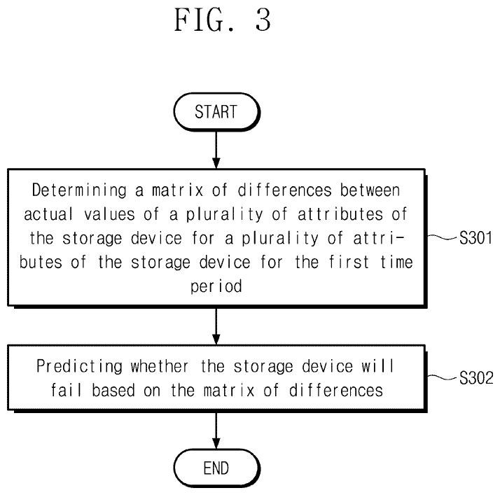

FIG. 3 illustrates a flowchart of a method of predicting a failure of a storage device according to an embodiment of the present disclosure.

It should be understood by those skilled in the art that the storage device described herein may be any type of storage device for storing data such as a mechanical hard drive, an SSD, and the like.

As an example, the attributes of the SSD may be SMART attributes or Telemetry attributes.

The SMART attributes or the Telemetry attributes may provide more comprehensive and detailed information about the internal state of the SSD.

SMART attributes are a set of data points or indicators provided by the Self-Monitoring, Analysis, and Reporting Technology (SMART) system used in computer hard drives (HDDs) and SSDs. The SMART attributes may include a read error rate (e.g., measure of frequency of error when reading data from the driver), reallocated sector count (e.g., indicates number of bad sectors that have been found and replaced with spare sectors), spin-up time, start/stop count, temperature, and power-on hours.

The Telemetry attributes may include metrics and data points collected about the performance and operation of a system. The metrics for a storage device may include memory usage, response times, throughput, failure rates, up-time, and failure rates.

It should be understood by those in the art that for other types of storage devices, any attribute that reflects the internal state (or state of health) of the storage device may be selected.

Referring to FIG. 3, at step S301, a matrix of differences between actual values of a plurality of attributes of the storage device for a first time period and predicted values of the plurality of attributes of the storage device for the first time period is determined. The actual values may be obtained during the first time period.

As an example, for convenience in describing the present disclosure, the actual values of 2 attributes at N moments (e.g., which may be represented as a matrix of N rows and 2 columns) that occur within the first time period are illustrated as an example. It should be understood by those skilled in the art that the number of attributes may be any other value.

As an example, intervals between each two adjacent moments of the N moments can be the same or different.

As an example, the predicted values of the plurality of attributes for the first time period are determined based on the actual values of the plurality of attributes of the storage device for a second time period by using a trained model. The process of training the model is described below. As an example, inputs to the trained model may be actual values of the plurality of attributes at a plurality of moments in the past (e.g., the plurality of moments may be N moments or some other number of moments) and outputs may be predicted values of the attributes at a plurality of moments (e.g., N moments) in the future.

For example, values of the 2 attributes of the storage device at N moments (e.g., which may be represented as a matrix of N rows and 2 columns) of the first time period may be predicted by using a trained model based on actual values of the 2 attributes of the storage device at a plurality of moments obtained for the second time period prior to the first time period. Accordingly, the matrix of differences is a matrix of N rows and 2 columns when two attributes are considered.

The matrix of differences represents magnitudes of mutations in the attributes. For example, 2 differences corresponding to a first moment of the N moments may represent a mutation of a first attribute of the 2 attributes and a mutation of a second attribute of the 2 attributes, respectively.

A model may be trained based on training methods to enable the model to predict future values of the attributes of the storage device based on obtained actual values of the attributes of the storage device.

However, a magnitude of a mutation of an attribute is not necessarily positively correlated with the probability that the storage device will fail. For example, although a mutation of a first attribute is large, the mutation of the first attribute may be common for healthy storage devices, and therefore, the large mutation of the first attribute does not indicate a high probability that the storage device will fail. Conversely, even though a mutation of a second attribute is small, if a frequency of the mutation of the attribute is low for healthy storage devices, the mutation of the attribute for the storage device may imply that the probability that the storage device will fail is high because the mutation of the attribute occurs infrequently.

As an example, a matrix of weights for attributes (e.g., an attribute mutation rarity weight matrix or a mutation rarity weight matrix, etc.) may also be determined during the training phase of the model described above. In an embodiment, the less common the mutation of the attribute is (or the less frequently the mutation occurs), the greater the weight for the mutation of the attribute is. For example, for two attributes having the same mutation value, the occurrence of a mutation of one attribute of which the mutation occurrence frequency is low in healthy storage devices means a greater probability that the storage device will fail compared to the occurrence of a mutation of another attribute of which the mutation occurrence frequency is high in healthy storage devices.

The presence of a mutation in an attribute may mean that a difference between an actual value and a predicted value of the attribute is less than a preset threshold value. For example, if the difference between the actual value and the corresponding predicted value of the attribute is less than the preset threshold, it means that there is no mutation for the attribute, and conversely, when the difference between the actual value and the corresponding predicted value of the attribute is not less than the preset threshold (e.g., greater than or equal the present threshold), it means that there is a mutation for the attribute.

As described above, a weight for an attribute indicates a rarity with which the attribute has a mutation. For example, the weight for the attribute being large indicates that mutations of the attribute are rare in the healthy storage devices, and the weight for the attribute being small indicates that mutations of the attribute are common in the healthy storage devices.

As an example, the matrix of weights for the attributes may be determined during a training phase of the model described above.

As an example, the above model may be trained based on a loss function as follows:

Loss=Δw+1/w, wherein Δ denotes the mutation of attribute and w denotes the weight corresponding to the attribute.

During the training process, w is determined to obtain the matrix of weights for the attributes by varying the learnable parameter w such that the Loss becomes smaller and tends to converges. The above method of obtaining the matrix of weights for the attributes is merely exemplary and does not limit the present disclosure.

After determining the matrix of weights for attributes described above, parameters and the matrix of weights for attributes of the model are fixed, and thus in the inference phase of the model, inputs of the model are historical actual values of the attributes of the storage device and outputs of the model are predicted values of the attributes of the storage device.

When the training of the model uses attribute data of healthy storage devices, an occurrence frequency of a mutation of an attribute being large may indicate that the mutation of the attribute is common in healthy storage devices. An occurrence frequency of the mutation of the attribute being small may indicate that the mutation of the attribute is uncommon in healthy storage devices, and therefore, when the mutation of the attribute occurs in the storage device, it means the probability that the storage device will fail is high.

As an example, the model may include an attribute weight perceptron and a time sequential predictor.

As an example, the attribute weight perceptron and the time sequential predictor may be jointly trained based on the loss function described above, wherein the matrix of weights for attributes is determined by the attribute weight perceptron and the time sequential predictor is used to predict values of the attributes of the storage device, i.e., the predicted values corresponding to the actual values.

As an example, the attribute weight perceptron may be implemented by a linear layer whose network dimensions correspond to the dimensions of the attributes (e.g., 2).

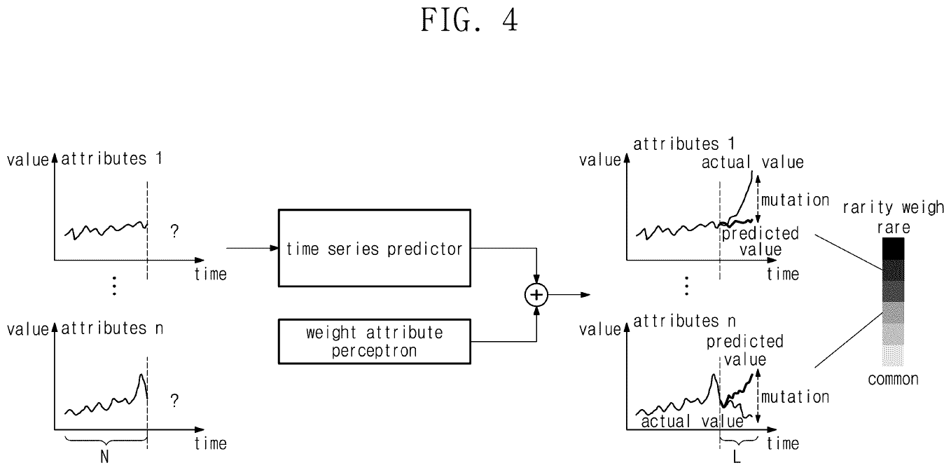

FIG. 4 illustrates a schematic diagram for determining a matrix of differences (or mutation matrix) and weights of mutation rarefactions of attributes according to an embodiment of the present disclosure.

Referring to FIG. 4, the matrix of weights for attributes may be determined based on the time series predictor and the weight attribute perceptron during the training phase, and the predicted values of the attributes of the storage device may be determined based on the time sequential predictor in the inference phase.

Returning to FIG. 3, at step S302, whether the storage device will fail is predicted based on the matrix of differences.

As an example, the predicting of whether the storage device will fail based on the matrix of differences includes: predicting whether the storage device will fail based on a first similarity and a second similarity, wherein the first similarity is a similarity between the matrix of differences and matrices of differences for a plurality of healthy storage devices (e.g., a first matrices). The matrices of differences for the plurality of healthy devices includes a matrix of differences between actual values of the plurality of attributes of each of the healthy storage devices obtained during a time period with a first length of time (e.g., a first duration) and predicted values of the plurality of attributes of each of the healthy storage devices obtained during the time period with the first length of time. The second similarity is a similarity between the matrix of differences and matrices of differences for a plurality of failed storage devices (e.g., second matrices). The matrices of differences for the plurality of failed devices includes a matrix of differences between actual values of the plurality of attributes of each of the failed storage devices obtained during the time period with the first length of time (e.g., a duration) before each failed storage device actually failed and predicted values of the plurality of attributes for each of the failed storage devices for the time period with the first length of time before each of the failed storage devices actually failed. In an embodiment, the first time length (e.g., a duration) is the same as a time length (e.g., a duration) of the first time period.

As an example, a trained model may be utilized to predict values of the attributes of the storage device for a subsequent time period based on the obtained actual values of the attributes of the storage device. After obtaining actual values of the attributes for the subsequent time period, the matrix of differences between the predicted values of the attributes for the subsequent time period and the actual values of the attributes of the storage device for the subsequent time period may be calculated. If the storage device fails after the subsequent time period, the matrix of differences is a matrix of differences for a failed storage device, and if the storage device does not fail after the subsequent time period, the matrix of differences becomes a matrix of differences of a healthy storage device.

The first time length being the same as a time length of the first time period may cause the matrix of differences for the storage device, the first matrix of differences for the healthy storage device, and the second matrix of differences for the failed storage device to have the same form (e.g., all are matrices with N rows and 2 columns).

As an example, the predicting of whether the storage device will fail based on the first similarity and the second similarity includes: determining that the storage device will not fail when the first similarity is greater than the second similarity; and determining that the storage device will fail when the first similarity is not greater than the second similarity.

As an example, the first similarity is indicative of a sum of distances between the matrix of differences and the first matrices of differences for the plurality of healthy storage devices, and the second similarity is indicative of a sum of distances between the matrix of differences and the second matrices of differences for the plurality of failed storage devices.

For example, for 8 healthy storage devices and 6 failed storage devices, a distance (e.g., Euclidean distance, Manhattan distance, etc.) between a matrix of differences for a storage device and a matrix of differences for each of the 8 healthy storage devices may be calculated, and then a sum of the 8 distances may be used as the distance between the matrix of differences for the storage device and the matrices of differences for the 8 healthy storage devices. Similarly, a distance between the matrix of difference for the storage device and a matrix of differences for each of the 6 failed storage devices may be calculated, and then a sum of the 6 distances may be used as the distance between the matrix of differences for the storage device and the matrices of differences of the 6 failed storage devices.

As an example, the method further includes: determining first distances between the matrix of differences and the first matrices of differences for the plurality of healthy storage devices based on a matrix of first weights for the attributes, the matrix of differences, and the first matrices of differences for the plurality of healthy storage devices; determining second distances between the matrix of differences and the second matrices of differences for the plurality of failed storage devices based on a matrix of second weights for the attributes, the matrix of differences and the second matrices of differences for the plurality of failed storage devices. In an embodiment, the higher a frequency of occurrence of a mutation of an attribute in healthy storage devices is, the greater a weight of the attribute in the matrix of weights for the attributes corresponding to the attribute is.

As an example, the determining of the first distances between the matrix of differences and the first matrices of differences for the plurality of healthy storage devices based on the matrix of first weights for the attributes, the matrix of difference and the first matrices of differences for the plurality of healthy storage devices includes: using a product of a difference between each element of the matrix of differences and a corresponding element of the first matrix of differences for each healthy storage device and a weight element corresponding to each element in the matrix of first weights for the attributes as a healthy weight difference corresponding to each element of the matrix of differences; and obtaining an arithmetic square root of the healthy weight differences corresponding to elements of the matrix of differences as a distance between the matrix of differences and the first matrix of differences for each healthy storage device; and the determining of the second distances between the matrix of differences and the second matrices of differences for the plurality of failed storage devices based on the matrix of second weights for the attributes, the matrix of differences and the second matrices of differences for the plurality of failed storage devices includes: using a product of a difference between each element of the matrix of differences and a corresponding element of the second matrix of differences for each failed storage device and a weight element corresponding to each element in the matrix of second weights for the attributes as a failure weight difference corresponding to each element of the matrix of differences; and obtaining an arithmetic square root of the failure weight differences corresponding to elements of the matrix of differences as a distance between the matrix of differences and the second matrix of differences for each failed storage device.

For example, assuming that Dᵢⱼ denotes an element of the ith row and jth column of the matrix of differences, Wᵢⱼ denotes an element of the ith row and jth column of the matrix of weights, Hᵢⱼₖ denotes an element of the ith row and jth column of the matrix of difference for the kth healthy storage device, and Fᵢⱼₗ denotes an element of the ith row and jth column of the matrix of differences for the lth failed storage device, then the distance between the matrix of differences and the matrix of differences for the kth healthy storage device may be calculated by Equation 1.

$$\sqrt{{\sum }_{i j} {{W}_{i j}^{2} ( {D}_{i j} - {H}_{ijk} )}^{2}} \qquad [ Equation 1 ]$$

Similarly, the distance between the matrix of differences and the matrix of differences for the lth failed storage device may be calculated by Equation 2.

$$\sqrt{{\sum }_{i j} {{W}_{i j}^{2} ( {D}_{i j} - {F}_{ijl} )}^{2}} , \qquad [ Equation ]$$

wherein i=1, 2 . . . N, j=1, 2 . . . M, and M expresses the number of attributes for prediction.

As an example, the second similarity includes a third similarity between the matrix of differences and matrices of differences for a plurality of failed storage devices having a first predetermined type of failure, and a fourth similarity between the matrix of differences and matrices of differences for a plurality of failed storage devices having a second predetermined type of failure.

As an example, the predicting of whether the storage device will fail based on the first similarity and the second similarity includes: determining a minimum value of the first similarity, the third similarity, and the fourth similarity; determining that the storage device will not fail when the minimum value is the first similarity; and determining that the storage device will fail with the first predetermined type of failure when the minimum value is the third similarity; and determining that the storage device will fail with the second predetermined type of failure when the minimum value is the fourth similarity.

As an example, the predicting of whether the storage device will fail based on the first similarity and the second similarity includes: determining that the storage device will not fail when the first similarity is greater than the second similarity and greater than a first threshold; and/or, determining that the storage device will fail with a first predetermined type of failure when the first similarity is greater than the second similarity and not greater than a first threshold; and/or, determining that the storage device will fail with a second predetermined type of failure when the first similarity is not greater than the second similarity and is greater than a second threshold; and/or, determining that the storage device will fail with a third predetermined type of failure when the first similarity is not greater than the second similarity and is not greater than the second threshold.

The first predetermined type of failure, the second predetermined type of failure, the third predetermined type of failure, the first level of failure, the second level of failure, the third level of failure, and the fourth level of failure described herein are for purposes of explanation, and do not limit the severity of the failures, unless otherwise clearly stated.

As an example, the method further includes: when determining that the storage device will fail with the second predetermined type of failure, analyzing the second predetermined type of failure based on at least one of: determining that the storage device will not fail when a similarity between the matrix of differences for the storage device and matrices of difference for other storage devices is less than a third threshold; and determining that the storage device will not fail when there is a temporal and/or spatial aggregation of the second predetermined type of failures for a plurality of storage devices. The storage device and the other storage devices may be located together on a same server.

As an example, the calculation of the similarity may refer to the calculation method for a similarity described above.

As an example, a prediction as to whether the storage device will fail may also be made in conjunction with a predicted subsequent failure for the storage device. For example, if a current failure prediction indicates that a minor failure of the storage device will occur, the storage device may be left untouched, and if a subsequent failure prediction indicates that a more serious failure of the storage device will occur, it may be determined that the storage device will fail and a prompt treatment is required. For example, a notification of a failure may only be generated when a serious failure is predicted.

As an example, storage devices (e.g., SSDs) on the same server may have similar workloads and data patterns. If a mutation for one SSD is similar to mutations for other SSDs on the same server, the mutation for the one SSD may indicate that the one SSD will not fail. Otherwise, the mutation for the one SSD may indicate that the one SSD will fail.

As an example, when a number of predicted minor failures for storage devices are clustered for a time or location (e.g., the same server, the same server room), these minor failures may be predicted due to external factors such as server hardware, temperature, etc., and thus need not be treated as actual failures for the storage devices.

As an example, a similarity between mutations of a particular SSD and that of both healthy SSDs and failed SSDs can be continuously tracked. Based on the change trend and range of the similarity, a level of failure may be automatically determined. For example, if the mutations of the particular SSD become increasingly similar to that of healthy SSDs, the failure may be deemed minor.

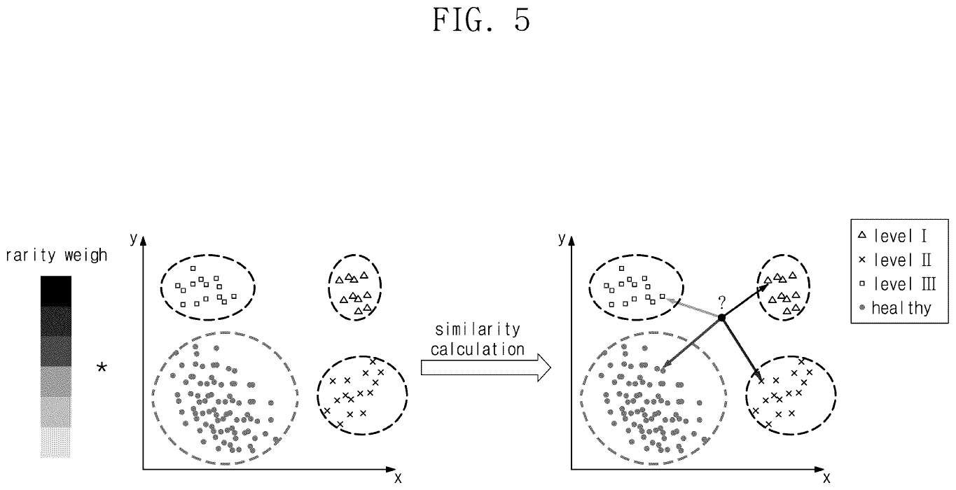

FIG. 5 illustrates a schematic diagram of an example of a method of predicting a failure of a storage device according to an embodiment of the present disclosure.

Referring to FIG. 5, distances between the matrix of differences for a storage device and each of 4 clusters of matrices of differences may be determined based on the matrix of differences (mutation matrix) for the storage device and weights for mutations of attributes, wherein the 4 clusters denote a first cluster of matrices of differences corresponding to storage devices having a first level of failure, a second cluster of matrices of differences corresponding to storage devices having a second level of failure, a third cluster of matrices of differences corresponding to storage devices having a third level of failure, and a fourth cluster of matrices of differences corresponding to healthy storage devices.

A distance between the matrix of differences of the storage device and each of the 4 clusters may be determined based on the method described above, and in an embodiment, whether the storage device will fail is determined based on the smallest value of the distances.

As an example, when the distance between the matrix of differences for the storage device and the first cluster is the smallest value, it may be determined that the storage device will fail with the first level of failure, when the distance between the matrix of differences for the storage device and the second cluster (or the third cluster) is the smallest value, it may be determined that the storage device will fail with the second level of failure (or the third level of failure), and when the distance between the matrix of differences for the storage device and the fourth cluster is the smallest value, it may be determined that that the storage device will not fail.

As an example, when a first level of failure (e.g., a severe failure) occurs, it indicates that the storage device will fail with a severe failure that requires an immediate treatment, and when the second level of failure (e.g., a minor failure) occurs, the second level of failure may be withheld and further failure diagnosis may be required. For example, a notification may be generated when the first level of failure is determined, and this notification may be omitted when the second level of failure is determined.

As an example, if the distance between the matrix of differences for the storage device and each cluster of matrices of differences is greater than a specific threshold, it may be determined that the storage device will experience a minor failure and further diagnosis and processing may be required.

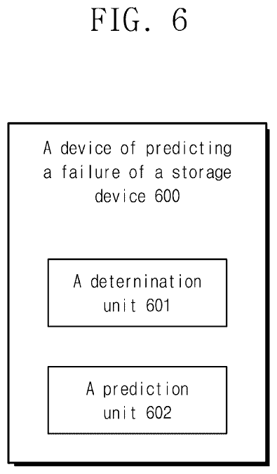

The method of predicting a failure of a storage device according to an embodiment of the present disclosure are described above with reference to FIGS. 1 to 5, and a device of predicting a failure of a storage device, an electronic device, a storage device, and a system according to an embodiment of the present disclosure are described below with reference to FIGS. 6 to 11.

FIG. 6 illustrates a block diagram of a structure of a device for predicting a failure of a storage device according to an embodiment of the present disclosure.

Referring to FIG. 6, the device for predicting a failure 600 may include a determination unit 601 and a prediction unit 602. The device for predicting a failure 600 may additionally include other components, and that at least one of components included in the device of predicting a failure 600 may be combined or split. The determination unit 601 and a prediction unit 602 may each be implemented by a logic circuit or a processor.

As an example, the determining unit 601 may be configured to determine a matrix of differences between actual values of a plurality of attributes of the storage device obtained during a first time period and predicted values of the plurality of attributes of the storage device for the first time period.

As an example, the prediction unit 602 may be configured to predict whether the storage device will fail based on the matrix of differences.

As an example, the prediction unit 602 may be configured to predict whether the storage device will fail based on a first similarity and a second similarity, wherein the first similarity is a similarity between the matrix of differences and first matrices of differences for a plurality of healthy storage devices, where the first matrices of differences for the plurality of healthy devices includes a matrix of differences between actual values of the plurality of attributes of each of the healthy storage devices obtained during a time period with a first length of time (e.g., a duration) and predicted values of the plurality of attributes of each of the healthy storage devices obtained during the time period with the first length of time, the second similarity is a similarity between the matrix of differences and a second matrices of differences for a plurality of failed storage devices, the second matrices of differences for the plurality of failed devices includes a matrix of differences between actual values of the plurality of attributes of each of the failed storage devices obtained during the time period with the first length of time before each failed storage device actually failed and predicted values of the plurality of attributes of each of the failed storage devices for the time period with the first length of time before each failed storage device actually failed, and wherein the first time length (e.g., a duration) is the same as a time length (e.g., a duration) of the first time period.

As an example, the prediction unit 602 may be configured to: determine that the storage device will not fail when the first similarity is greater than the second similarity; and determine that the storage device will fail when the first similarity is not greater than the second similarity.

As an example, the first similarity is indicative of a sum of distances between the matrix of differences and the first matrices of differences for the plurality of healthy storage devices, and the second similarity is indicative of a sum of distances between the matrix of differences and the second matrices of differences for the plurality of failed storage devices.

As an example, the prediction unit 602 may be configured to: determine first distances between the matrix of differences and the first matrices of differences for the plurality of healthy storage devices based on a matrix of first weights for the attributes, the matrix of differences, and the first matrices of differences for the plurality of healthy storage devices; and determine second distances between the matrix of differences and the second matrices of differences for the plurality of failed storage devices based on a matrix of second weights for the attributes, the matrix of differences and the second matrices of differences for the plurality of failed storage devices. In an embodiment, the higher a frequency of occurrence of a mutation of an attribute in the healthy storage devices is, the greater a weight of the attribute in the matrix of weights for the attributes corresponding to the attribute is.

As an example, the prediction unit 602 may be configured to: use a product of a difference between each element of the matrix of differences and a corresponding element of the first matrix of differences for each healthy storage device and a weight element corresponding to each element in the matrix of first weights for the attributes as a healthy weight difference corresponding to each element of the matrix of differences; obtain an arithmetic square root of the healthy weight differences corresponding to elements of the matrix of differences as a distance between the matrix of differences and the first matrix of differences for each healthy storage device; use a product of a difference between each element of the matrix of differences and a corresponding element of the second matrix of differences for each failed storage device and a weight element corresponding to each element in the matrix of second weights for the attributes as a failure weight difference corresponding to each element of the matrix of differences; and obtain an arithmetic square root of the failure weight differences corresponding to elements of the matrix of differences as a distance between the matrix of differences and the first matrix of differences for each failed storage device.

As an example, the second similarity includes a third similarity between the matrix of differences and matrices of differences for a plurality of failed storage devices having a first predetermined type of failure, and a fourth similarity between the matrix of differences and matrices of differences for a plurality of failed storage devices having a second predetermined type of failure.

As an example, the prediction unit 602 may be configured to: determine a minimum value of the first similarity, the third similarity, and the fourth similarity; determine that the storage device will not fail when the minimum value is the first similarity; determine that the storage device will fail with the first predetermined type of failure when the minimum value is the third similarity; and determine that the storage device will fail with the second predetermined type of failure when the minimum value is the fourth similarity.

As an example, the prediction unit 602 may be configured to: determine that the storage device will not fail when the first similarity is greater than the second similarity and greater than a first threshold; and/or, determine that the storage device will fail with a first predetermined type of failure when the first similarity is greater than the second similarity and not greater than a first threshold; and/or, determine that the storage device will fail with a second predetermined type of failure when the first similarity is not greater than the second similarity and is greater than a second threshold; and/or, determine that the storage device will fail with a third predetermined type of failure when the first similarity is not greater than the second similarity and is not greater than the second threshold.

As an example, the device for predicting a failure 600 may further include: an analysis unit (e.g., a logic circuit or processor) configured to when determining that the storage device will fail with the second predetermined type of failure, analyze the second predetermined type of failure based on at least one of: determining that the storage device will not fail when a similarity between the matrix of differences for the storage device and matrices of difference for other storage devices on a server on which the storage device is located is less than a third threshold; and determining that the storage device will not fail when there is a temporal and/or spatial aggregation of the second predetermined type of failures for a plurality of storage devices on the server.

As an example, the predicted values of the plurality of attributes for the first time period are determined based on actual values of the plurality of attributes of the storage device obtained during a second time period by using a trained model, wherein the matrix of first weights and the matrix of second weights is determined during a training phase of the model.

According to another aspect of embodiments of the present disclosure, there is provided a computer readable storage medium storing a computer program that when executed by a processor causes the processor to implement the method of predicting a failure of a storage device as described herein.

An embodiment of the disclosure provides a more nuanced and accurate method for predicting storage device failures by considering attribute mutations and using a matrix-based approach to evaluate the risk of failure.

In this embodiment, the system calculates a matrix of differences by comparing the actual values of the storage device's attributes with their predicted values over a specific time period. Each element in this matrix represents the difference between the actual and predicted value of a particular attribute at a given moment. A mutation is identified when the difference between the actual and predicted values for an attribute exceeds a certain threshold. This indicates that the attribute is behaving in an unusual or unexpected manner, which could be a sign of a developing failure. If the difference is less than the threshold, it is considered normal, and no mutation is noted. During the model training phase, the system assigns weights to different attributes based on how common or rare their mutations are in healthy storage devices. Attributes that rarely mutate in healthy devices are given higher weights, meaning that any mutation in these attributes is considered more significant and potentially indicative of a failure. Conversely, attributes that frequently mutate without leading to failures are given lower weights. When the system calculates the matrix of differences, it applies these weights to emphasize or de-emphasize certain mutations. For instance, a rare mutation in an attribute with a high weight will have a greater impact on the failure prediction than a common mutation in an attribute with a low weight. This weighted analysis helps the system more accurately assess the likelihood of failure by focusing on the most critical mutations. The system compares the matrix of differences for the current storage device with matrices from known healthy and failed device. It uses the weighted distances between these matrices to determine whether the current mutations are more similar to those found in healthy or failed devices. If the mutations are more similar to those found in failed devices, the system predicts that the storage device is likely to fail. The system can also categorize the severity of the predicted failure by comparing the matrix of differences against clusters of matrices associated with different levels of failure severity. This allows for a more granular prediction, indicating not just whether a failure will occur, but also how severe it is likely to be. Further, the system may continuously adapt by incorporating new data and updating the weights and prediction models, which allows it to better identify and consider mutations over time.

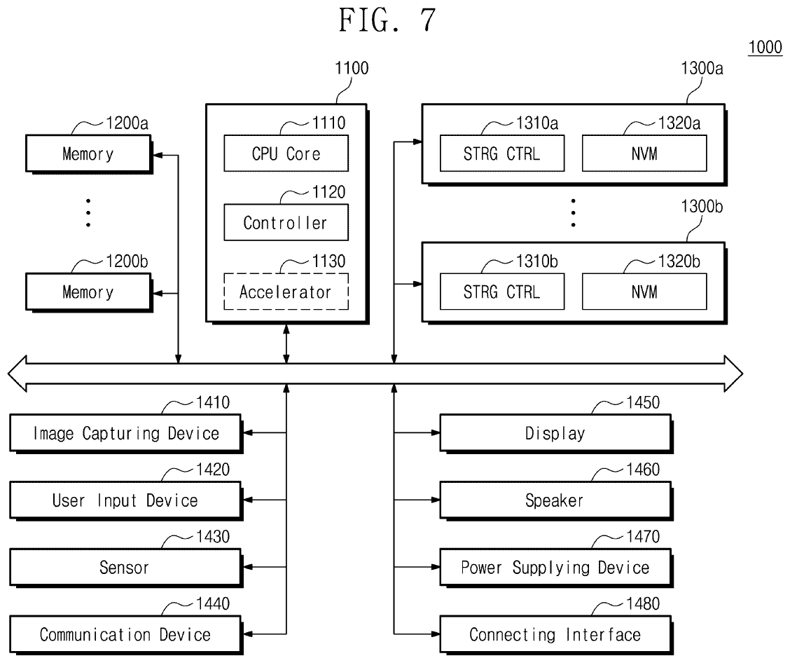

FIG. 7 is a schematic diagram of an electronic device 1000 according to an embodiment of the present disclosure.

The electronic device 1000 of FIG. 7 may be a mobile system, such as a portable communication terminal (e.g., a mobile phone), a smartphone, a tablet personal computer (PC), a wearable device, a healthcare device, or an Internet of things (IOT) device. However, the electronic device 1000 of FIG. 7 is not limited to the mobile system and may be a PC, a laptop computer, a server, a media player, or an automotive device (e.g., a navigation device).

Referring to FIG. 7, the electronic device 1000 may include a main processor 1100, memories (e.g., 1200a and 1200b), and storage devices (e.g., 1300a and 1300b). In addition, the electronic device 1000 may include at least one of an image capturing device 1410 (e.g., a camera), a user input device 1420, a sensor 1430, a communication device 1440 (e.g., a transceiver, modem, etc.), a display 1450, a speaker 1460, a power supplying device 1470, and a connecting interface 1480 (e.g., an interface circuit).

The main processor 1100 may control all operations of the electronic device 1000, more specifically, operations of other components included in the electronic device 1000. The main processor 1100 may be implemented as a general-purpose processor, a dedicated processor, or an application processor.

The main processor 1100 may include at least one CPU core 1110 and further include a controller 1120 (e.g., a controller circuit) configured to control the memories 1200a and 1200b and/or the storage devices 1300a and 1300b. In some embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the electronic device 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, stage-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVM (Non-Volatile Memory)s 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the electronic device 1000 or implemented in the same package as the main processor 1100. In addition, the storage devices 1300a and 1300b may have types of solid-state devices (SSDs) or memory cards and be removably combined with other components of the system 100 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may capture still images or moving images. The image capturing device 1410 may include or be a camera, a camcorder, and/or a webcam.

The user input device 1420 may receive various types of data input by a user of the electronic device 1000 and include a touch pad, a keypad, a keyboard, a mouse, and/or a microphone.

The sensor 1430 may detect various types of physical quantities, which may be obtained from the outside of the electronic device 1000, and convert the detected physical quantities into electric signals. The sensor 1430 may include or be a temperature sensor, a pressure sensor, an illuminance sensor, a position sensor, an acceleration sensor, a biosensor, and/or a gyroscope sensor.

The communication device 1440 may transmit and receive signals between other devices outside the electronic device 1000 according to various communication protocols. The communication device 1440 may include an antenna, a transceiver, and/or a modem.

The display 1450 and the speaker 1460 may serve as output devices configured to respectively output visual information and auditory information to the user of the electronic device 1000.

The power supplying device 1470 may appropriately convert power supplied from a battery embedded in the electronic device 1000 and/or an external power source, and supply the converted power to each of components of the electronic device 1000.

The connecting interface 1480 may provide connection between the electronic device 1000 and an external device, which is connected to the electronic device 1000 and capable of transmitting and receiving data to and from the electronic device 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

According to an exemplary embodiment of the present disclosure, there is provided an electronic device, including: a memory (for example, memories 1200a and 1200b of FIG. 7) storing one or more instructions; and storage devices (for example, storage devices 1300a and 1300b of FIG. 7); and a main processor (for example, main processor 1100 of FIG. 7) configured to execute the one or more instructions to cause the host processor to perform the method of predicting a failure of a storage device as described above.

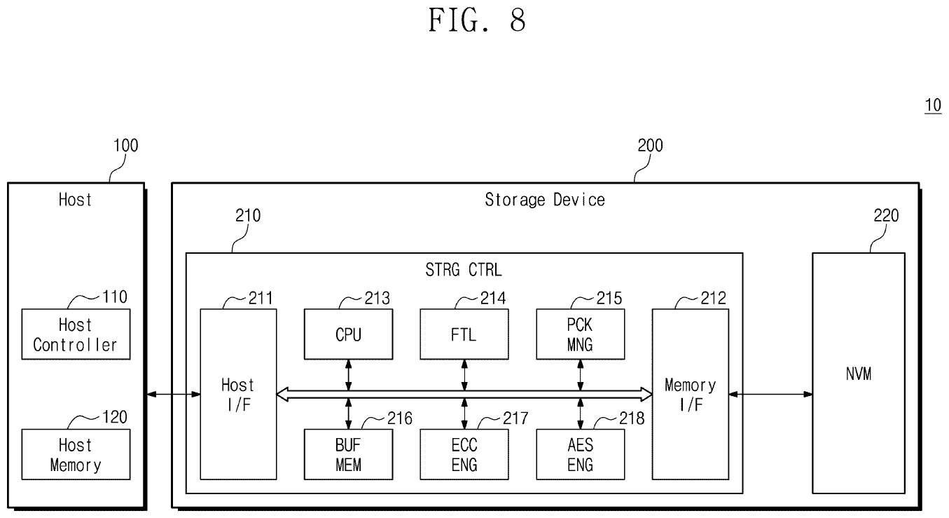

FIG. 8 is a block diagram of a host storage system 10 according to an embodiment of the present disclosure.

The host storage system 10 may include a host 100 and a storage device 200. Further, the storage device 200 may include a storage controller 210 (e.g., a controller circuit) and an NVM 220. According to an example embodiment, the host 100 may include a host controller 110 (e.g., a controller circuit) and a host memory 120. The host memory 120 may serve as a buffer memory configured to temporarily store data to be transmitted to the storage device 200 or data received from the storage device 200.

The storage device 200 may include storage media configured to store data in response to requests from the host 100. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 100 and the storage device 200 may generate a packet according to an adopted standard protocol and transmit the packet.

When the NVM 220 of the storage device 200 includes a flash memory, the flash memory may include a 2D NAND memory array or a 3D (or vertical) NAND (VNAND) memory array. As another example, the storage device 200 may include various other kinds of NVMs. For example, the storage device 200 may include magnetic RAM (MRAM), spin-transfer torque MRAM, conductive bridging RAM (CBRAM), ferroelectric RAM (FRAM), PRAM, RRAM, and various other kinds of memories.

According to an embodiment, the host controller 110 and the host memory 120 may be implemented as separate semiconductor chips. According to some embodiments of the present disclosure, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 220 or an operation of storing data (e.g., read data) of the NVM 220 in the buffer region.

The storage controller 210 may include a host interface 211, a memory interface 212, and a CPU 213. Further, the storage controllers 210 may further include a flash translation layer (FTL) 214, a packet manager 215, a buffer memory 216, an error correction code (ECC) engine 217, and an advanced encryption standard (AES) engine 218. The storage controllers 210 may further include a working memory (not shown) in which the FTL 214 is loaded. The CPU 213 may execute the FTL 214 to control data write and read operations on the NVM 220.

The host interface 211 may transmit and receive packets to and from the host 100. A packet transmitted from the host 100 to the host interface 211 may include a command or data to be written to the NVM 220. A packet transmitted from the host interface 211 to the host 100 may include a response to the command or data read from the NVM 220. The memory interface 212 may transmit data to be written to the NVM 220 to the NVM 220 or receive data read from the NVM 220. The memory interface 212 may be configured to comply with a standard protocol, such as Toggle or open NAND flash interface (ONFI).

The FTL 214 may perform various functions, such as an address mapping operation, a wear-leveling operation, and a garbage collection operation. The address mapping operation may be an operation of converting a logical address received from the host 100 into a physical address used to actually store data in the NVM 220. The wear-leveling operation may be a technique for preventing excessive deterioration of a specific block by allowing blocks of the NVM 220 to be uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data of the existing block to a new block.

The packet manager 215 may generate a packet according to a protocol of an interface, which consents to the host 100, or parse various types of information from the packet received from the host 100. In addition, the buffer memory 216 may temporarily store data to be written to the NVM 220 or data to be read from the NVM 220. Although the buffer memory 216 may be a component included in the storage controllers 210, the buffer memory 216 may be located outside the storage controllers 210.

The ECC engine 217 may perform error detection and correction operations on read data read from the NVM 220. More specifically, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

According to an embodiment of the present disclosure, a host storage system is provided, including: a host (for example, host 100 of FIG. 8) including a host memory (for example, host memory 110 of FIG. 8) and a host controller (for example, host controller 120 of FIG. 8); and a storage device (for example, storage device 200 of FIG. 8), wherein the host memory stores instructions that when executed by the host controller cause the host controller to perform the method of predicting a failure of a storage device as described above.

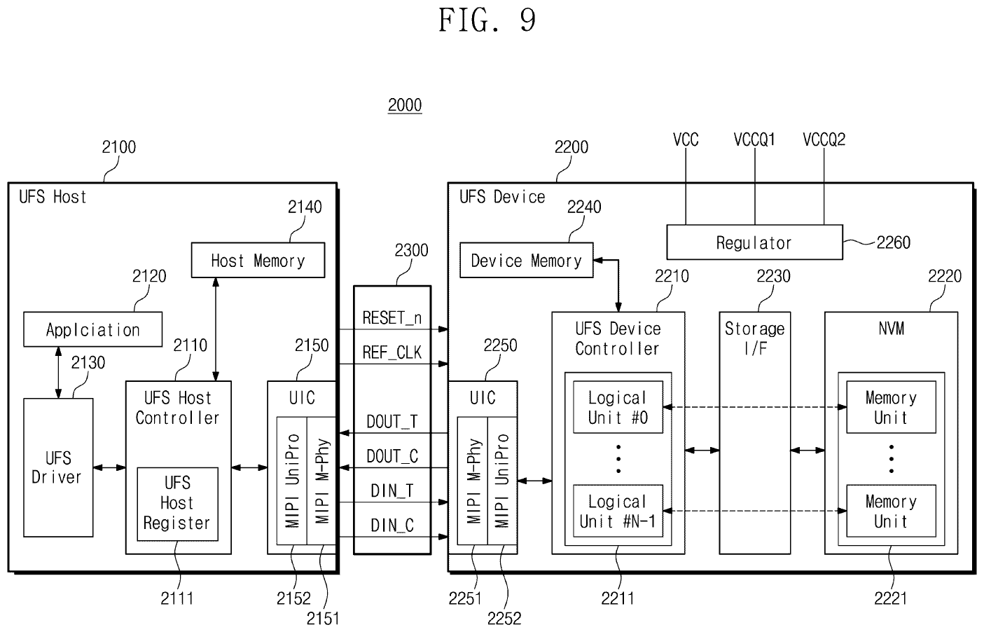

FIG. 9 is a block diagram of a UFS system 2000 according to an embodiment of the present disclosure.

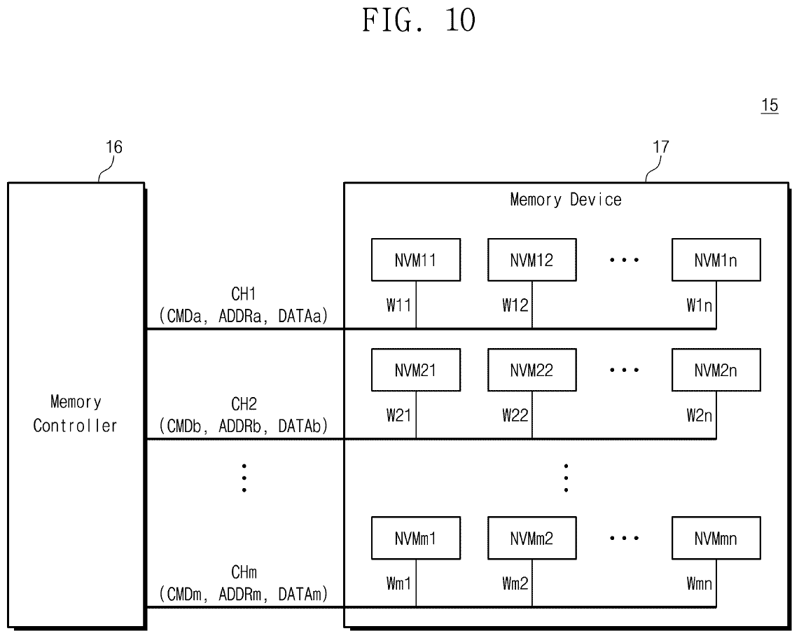

The UFS system 2000 may be a system conforming to a UFS standard announced by Joint Electron Device Engineering Council (JEDEC) and include a UFS host 2100, a UFS device 2200, and a UFS interface 2300. The above description of the electronic device 1000 of FIG. 10 may also be applied to the UFS system 2000 of FIG. 9 within a range that does not conflict with the following description of FIG. 9.

Referring to FIG. 9, the UFS host 2100 may be connected to the UFS device 2200 through the UFS interface 2300. When the main processor 1100 of FIG. 10 is an AP, the UFS host 2100 may be implemented as a portion of the AP. The UFS host controller 2110 and the host memory 2140 may respectively correspond to the controller 1120 of the main processor 1100 and the memories 1200a and 1200b of FIG. 10. The UFS device 2200 may correspond to the storage device 1300a and 1300b of FIG. 10, and a UFS device controller 2210 and an NVM 2220 may respectively correspond to the storage controllers 1310a and 1310b and the NVMs 1320a and 1320b of FIG. 10.

The UFS host 2100 may include a UFS host controller 2110, an application 2120, a UFS driver 2130, a host memory 2140, and a UFS interconnect (UIC) layer 2150. The UFS device 2200 may include the UFS device controller 2210, the NVM 2220, a storage interface 2230, a device memory 2240, a UIC layer 2250, and a regulator 2260. The NVM 2220 may include a plurality of memory units 2221. Although each of the memory units 2221 may include a V-NAND flash memory having a 2D structure or a 3D structure, each of the memory units 2221 may include another kind of NVM, such as PRAM and/or RRAM. The UFS device controller 2210 may be connected to the NVM 2220 through the storage interface 2230. The storage interface 2230 may be configured to comply with a standard protocol, such as Toggle or ONFI.

The application 2120 may refer to a program that is configured to communicate with the UFS device 2200 to use functions of the UFS device 2200. The application 2120 may transmit input-output requests (IORs) to the UFS driver 2130 for input/output (I/O) operations on the UFS device 2200. The IORs may refer to a data read request, a data storage (or write) request, and/or a data erase (or discard) request, without being limited thereto.

The UFS driver 2130 may manage the UFS host controller 2110 through a UFS-host controller interface (UFS-HCI). The UFS driver 2130 may convert the IOR generated by the application 2120 into a UFS command defined by the UFS standard and transmit the UFS command to the UFS host controller 2110. One IOR may be converted into a plurality of UFS commands. Although the UFS command may basically be defined by an SCSI standard, the UFS command may be a command dedicated to the UFS standard.

The UFS host controller 2110 may transmit the UFS command converted by the UFS driver 2130 to the UIC layer 2250 of the UFS device 2200 through the UIC layer 2150 and the UFS interface 2300. During the transmission of the UFS command, a UFS host register 2111 of the UFS host controller 2110 may serve as a command queue (CQ).

The UIC layer 2150 on the side of the UFS host 2100 may include a mobile industry processor interface (MIPI) M-PHY 2151 and an MIPI UniPro 2152, and the UIC layer 2250 on the side of the UFS device 2200 may also include an MIPI M-PHY 2251 and an MIPI UniPro 2252.

The UFS interface 2300 may include a line configured to transmit a reference clock signal REF_CLK, a line configured to transmit a hardware reset signal RESET n for the UFS device 2200, a pair of lines configured to transmit a pair of differential input signals DIN_t and DIN_c, and a pair of lines configured to transmit a pair of differential output signals DOUT_t and DOUT_c.

A frequency of a reference clock signal REF_CLK provided from the UFS host 2100 to the UFS device 2200 may be one of 19.2 MHz, 26 MHz, 38.4 MHz, and 52 MHz, without being limited thereto. The UFS host 2100 may change the frequency of the reference clock signal REF_CLK during an operation, that is, during data transmission/receiving operations between the UFS host 2100 and the UFS device 2200. The UFS device 2200 may generate cock signals having various frequencies from the reference clock signal REF_CLK provided from the UFS host 2100, by using a phase-locked loop (PLL). Also, the UFS host 2100 may set a data rate between the UFS host 2100 and the UFS device 2200 by using the frequency of the reference clock signal REF_CLK. That is, the data rate may be determined depending on the frequency of the reference clock signal REF CLK.

The UFS interface 2300 may support a plurality of lanes, each of which may be implemented as a pair of differential lines. For example, the UFS interface 2300 may include at least one receiving lane and at least one transmission lane. In FIG. 9, a pair of lines configured to transmit a pair of differential input signals DIN_T and DIN_C may constitute a receiving lane, and a pair of lines configured to transmit a pair of differential output signals DOUT_T and DOUT_C may constitute a transmission lane. Although one transmission lane and one receiving lane are illustrated in FIG. 9, the number of transmission lanes and the number of receiving lanes may be changed.

The receiving lane and the transmission lane may transmit data based on a serial communication scheme. Full-duplex communications between the UFS host 2100 and the UFS device 2200 may be enabled due to a structure in which the receiving lane is separated from the transmission lane. That is, while receiving data from the UFS host 2100 through the receiving lane, the UFS device 2200 may transmit data to the UFS host 2100 through the transmission lane. In addition, control data (e.g., a command) from the UFS host 2100 to the UFS device 2200 and user data to be stored in or read from the NVM 2220 of the UFS device 2200 by the UFS host 2100 may be transmitted through the same lane. Accordingly, between the UFS host 2100 and the UFS device 2200, there may be no need to further provide a separate lane for data transmission in addition to a pair of receiving lanes and a pair of transmission lanes.

The UFS device controller 2210 of the UFS device 2200 may control all operations of the UFS device 2200. The UFS device controller 2210 may manage the NVM 2220 by using a logical unit (LU) 2211, which is a logical data storage unit. The number of LUs 2211 may be 8, without being limited thereto. The UFS device controller 2210 may include an FTL and convert a logical data address (e.g., a logical block address (LBA)) received from the UFS host 2100 into a physical data address (e.g., a physical block address (PBA)) by using address mapping information of the FTL. A logical block configured to store user data in the UFS system 2000 may have a size in a predetermined range. For example, a minimum size of the logical block may be set to 4 Kbyte.

When a command from the UFS host 2100 is applied through the UIC layer 2250 to the UFS device 2200, the UFS device controller 2210 may perform an operation in response to the command and transmit a completion response to the UFS host 2100 when the operation is completed.

As an example, when the UFS host 2100 intends to store user data in the UFS device 2200, the UFS host 2100 may transmit a data storage command to the UFS device 2200. When a response (a ‘ready-to-transfer’ response) indicating that the UFS host 2100 is ready to receive user data (ready-to-transfer) is received from the UFS device 2200, the UFS host 2100 may transmit user data to the UFS device 2200. The UFS device controller 2210 may temporarily store the received user data in the device memory 2240 and store the user data, which is temporarily stored in the device memory 2240, at a selected position of the NVM 2220 based on the address mapping information of the FTL.

As another example, when the UFS host 2100 intends to read the user data stored in the UFS device 2200, the UFS host 2100 may transmit a data read command to the UFS device 2200. The UFS device controller 2210, which has received the command, may read the user data from the NVM 2220 based on the data read command and temporarily store the read user data in the device memory 2240. During the read operation, the UFS device controller 2210 may detect and correct an error in the read user data by using an ECC engine (not shown) embedded therein. More specifically, the ECC engine may generate parity bits for write data to be written to the NVM 2220, and the generated parity bits may be stored in the NVM 2220 along with the write data. During the reading of data from the NVM 2220, the ECC engine may correct an error in read data by using the parity bits read from the NVM 2220 along with the read data, and output error-corrected read data.

In addition, the UFS device controller 2210 may transmit user data, which is temporarily stored in the device memory 2240, to the UFS host 2100. In addition, the UFS device controller 2210 may further include an AES engine (not shown). The AES engine may perform at least one of an encryption operation and a decryption operation on data transmitted to the UFS device controller 2210 by using a symmetric-key algorithm.

The UFS host 2100 may sequentially store commands, which are to be transmitted to the UFS device 2200, in the UFS host register 2111, which may serve as a common queue, and sequentially transmit the commands to the UFS device 2200. In this case, even while a previously transmitted command is still being processed by the UFS device 2200, that is, even before receiving a notification that the previously transmitted command has been processed by the UFS device 2200, the UFS host 2100 may transmit a next command, which is on standby in the CQ, to the UFS device 2200. Thus, the UFS device 2200 may also receive a next command from the UFS host 2100 during the processing of the previously transmitted command. A maximum number (or queue depth) of commands that may be stored in the CQ may be, for example, 32. Also, the CQ may be implemented as a circular queue in which a start and an end of a command line stored in a queue are indicated by a head pointer and a tail pointer.

Each of the plurality of memory units 2221 may include a memory cell array (not shown) and a control circuit (not shown) configured to control an operation of the memory cell array. The memory cell array may include a 2D memory cell array or a 3D memory cell array. The memory cell array may include a plurality of memory cells. Although each of the memory cells is a single-level cell (SLC) configured to store 1-bit information, each of the memory cells may be a cell configured to store information of 2 bits or more, such as a multi-level cell (MLC), a triple-level cell (TLC), and a quadruple-level cell (QLC). The 3D memory cell array may include a vertical NAND string in which at least one memory cell is vertically oriented and located on another memory cell.

Voltages VCC, VCCQ, and VCCQ2 may be applied as power supply voltages to the UFS device 2200. The voltage VCC may be a main power supply voltage for the UFS device 2200 and be in a range of 2.4 V to 3.6 V. The voltage VCCQ may be a power supply voltage for supplying a low voltage mainly to the UFS device controller 2210 and be in a range of 1.14 V to 1.26 V. The voltage VCCQ2 may be a power supply voltage for supplying a voltage, which is lower than the voltage VCC and higher than the voltage VCCQ, mainly to an I/O interface, such as the MIPI M-PHY 2251, and be in a range of 1.7 V to 1.95 V. The power supply voltages may be supplied through the regulator 2260 to respective components of the UFS device 2200. The regulator 2260 may be implemented as a set of unit regulators respectively connected to different ones of the power supply voltages described above.

According to an embodiment of the present disclosure, a UFS system is provided, including: a UFS device (for example, UFS device 2200 of FIG. 9); a UFS host (for example, UFS host 2100 of FIG. 9) configured to perform the method of predicting a failure of a storage device as described above; and a UFS interface (for example, UFS interface 2300 of FIG. 9), used for a communication between the UFS device and the UFS host.

FIG. 10 is a block diagram of a memory system 15 according to an embodiment. Referring to FIG. 10, the memory system 15 may include a memory device 17 and a memory controller 16. The memory system 15 may support a plurality of channels CH1 to CHm, and the memory device 17 may be connected to the memory controller 16 through the plurality of channels CH1 to CHm. For example, the memory system 15 may be implemented as a storage device, such as an SSD.

The memory device 17 may include a plurality of NVM devices NVM11 to NVMmn. Each of the NVM devices NVM11 to NVMmn may be connected to one of the plurality of channels CH1 to CHm through a way corresponding thereto. For instance, the NVM devices NVM11 to NVM1n may be connected to a first channel CH1 through ways W11 to W1n, and the NVM devices NVM21 to NVM2n may be connected to a second channel CH2 through ways W21 to W2n. In an example embodiment, each of the NVM devices NVM11 to NVMmn may be implemented as an arbitrary memory unit that may operate according to an individual command from the memory controller 16. For example, each of the NVM devices NVM11 to NVMmn may be implemented as a chip or a die, but the inventive concept is not limited thereto.

The memory controller 16 may transmit and receive signals to and from the memory device 17 through the plurality of channels CH1 to CHm. For example, the memory controller 16 may transmit commands CMDa to CMDm, addresses ADDRa to ADDRm, and data DATAa to DATAm to the memory device 17 through the channels CH1 to CHm or receive the data DATAa to DATAm from the memory device 17.

The memory controller 16 may select one of the NVM devices NVM11 to NVMmn, which is connected to each of the channels CH1 to CHm, by using a corresponding one of the channels CH1 to CHm, and transmit and receive signals to and from the selected NVM device. For example, the memory controller 16 may select the NVM device NVM11 from the NVM devices NVM11 to NVM1n connected to the first channel CH1. The memory controller 16 may transmit the command CMDa, the address ADDRa, and the data DATAa to the selected NVM device NVM11 through the first channel CH1 or receive the data DATAa from the selected NVM device NVM11.

The memory controller 16 may transmit and receive signals to and from the memory device 17 in parallel through different channels. For example, the memory controller 16 may transmit a command CMDb to the memory device 17 through the second channel CH2 while transmitting a command CMDa to the memory device 17 through the first channel CH1. For example, the memory controller 16 may receive data DATAb from the memory device 17 through the second channel CH2 while receiving data DATAa from the memory device 17 through the first channel CH1.

The memory controller 16 may control all operations of the memory device 17. The memory controller 16 may transmit a signal to the channels CH1 to CHm and control each of the NVM devices NVM11 to NVMmn connected to the channels CH1 to CHm. For instance, the memory controller 16 may transmit the command CMDa and the address ADDRa to the first channel CH1 and control one selected from the NVM devices NVM11 to NVM1n.

Each of the NVM devices NVM11 to NVMmn may operate via the control of the memory controller 16. For example, the NVM device NVM11 may program the data DATAa based on the command CMDa, the address ADDRa, and the data DATAa provided to the first channel CH1. For example, the NVM device NVM21 may read the data DATAb based on the command CMDb and the address ADDb provided to the second channel CH2 and transmit the read data DATAb to the memory controller 16.

Although FIG. 10 illustrates an example in which the memory device 17 communicates with the memory controller 16 through m channels and includes n NVM devices corresponding to each of the channels, the number of channels and the number of NVM devices connected to one channel may be variously changed.

According to an embodiment of the present disclosure, there provides a storage system including: a memory device (for example, memory device 17) configured to perform the data compaction method performed by the storage device as described herein; and a memory controller (for example, memory controller 16) configured to perform the method of predicting a failure of a storage device as described herein.

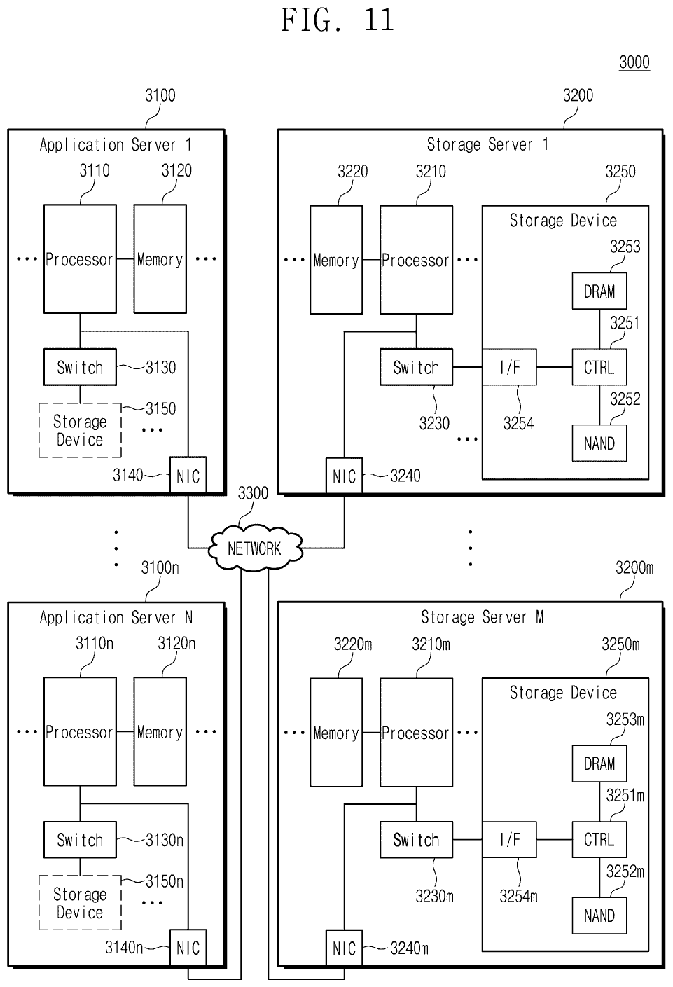

FIG. 11 is a diagram of a data center 3000 to which a storage device is applied according to an embodiment of the present disclosure.

Referring to FIG. 11, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to embodiments. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some embodiments, the numbers of processors 3210 and memories 3220 included in the storage server 3200 may be variously selected. In an embodiment, the processor 3210 and the memory 3220 may provide a processor-memory pair. In an embodiment, the number of processors 3210 may be different from the number of memories 3220. The processor 3210 may include a single-core processor or a multi-core processor. The above description of the storage server 3200 may be similarly applied to the application server 3100. In some embodiments, the application server 3100 may not include a storage device 3150. The storage server 3200 may include at least one storage device 3250. The number of storage devices 3250 included in the storage server 3200 may be variously selected according to embodiments.

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In an embodiment, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In another embodiment, the network 3300 may be a general network, such as a TCP/IP network. For example, the network 3300 may be implemented according to a protocol, such as FC over Ethernet (FCoE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. According to some embodiments of the present disclosure, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC (Network InterConnect) 3240. The switch 3230 may selectively connect the processor 3210 to the storage device 3250 or selectively connect the NIC 3240 to the storage device 3250 via the control of the processor 3210.

In an embodiment, the NIC 3240 may include a network interface card and a network adaptor. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In an embodiment, the NIC 3240 may be integrated with at least one of the processor 3210, the switch 3230, and the storage device 3250.

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

The controller 3251 may control all operations of the storage device 3250. In an embodiment, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

According to an embodiment of the present disclosure, a data center system (for example, data center 3000) is provided, including: a plurality of application servers (for example, application servers 3100-3100n); and a plurality of storage servers (for example, storage servers 3200-3200m), wherein each of the plurality of application servers and/or each of the storage servers, and each of the plurality of storage servers is configured to perform the method of predicting a failure of the storage device as described herein.

According to an embodiment of the present disclosure, there may be provided a computer-readable storage medium storing instructions, when executed by at least one processor, causing the at least one processor to implement the method of predicting a failure of the storage device according to the present disclosure. Examples of computer-readable storage media here include: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state Hard disk (SSD), card storage (such as multimedia card, secure digital (SD) card or extreme digital (XD) card), magnetic tape, floppy disk, magneto-optical data storage device, optical data storage device, hard disk, solid state disk and any other devices configured to store computer programs and any associated data, data files, and data structures in a non-transitory manner, and provide the computer programs and any associated data, data files, and data structures to the processor or the computer, so that the processor or the computer can execute the computer program. The computer program in the above-mentioned computer-readable storage medium may run in an environment deployed in computing equipment such as a client, a host, an agent device, a server, etc. In addition, in one example, the computer program and any associated data, data files and data structures are distributed on networked computer systems, so that computer programs and any associated data, data files, and data structures are stored, accessed, and executed in a distributed manner through one or more processors or computers.

According to an embodiment of the present disclosure, there may be provided a computer program product, wherein instructions in the computer program product may be executed by a processor of a computer device to implement the method of predicting a failure of the storage device described herein.

While the present disclosure has been described with reference to embodiments thereof, it will be apparent to those of ordinary skill in the art that various changes and modifications may be made thereto without departing from the spirit and scope of the present disclosure.

1. A method for predicting a failure of a storage device, comprising:
determining a matrix of differences between actual values of a plurality of attributes of the storage device obtained during a first time period and predicted values of the plurality of attributes of the storage device for the first time period; and
predicting whether the storage device will fail based on the matrix of differences.

2. The method of claim 1, wherein the predicting of whether the storage device will fail based on the matrix of differences comprises:
predicting whether the storage device will fail based on a first similarity between the matrix of differences and first matrices of differences for a plurality of healthy storage devices and a second similarity between the matrix of differences and second matrices of differences for a plurality of failed storage devices.

3. The method of claim 2,
wherein the first matrices of differences comprises a matrix of differences between actual values of the plurality of attributes of each of the healthy storage devices obtain during a time period with a first duration and predicted values of the plurality of attributes of the healthy storage devices for the time period with the first duration,
wherein the second matrices of differences for the plurality of failed devices comprises a matrix of differences between actual values of the plurality of attributes of each of the failed storage devices for the time period with the first duration before each failed storage device failed and predicted values of the plurality of attributes of each of the failed storage devices for the time period with the first duration before each failed storage device failed, and
wherein the first duration is the same as a duration of the first time period.

4. The method of claim 2, the predicting of whether the storage device will fail based on the matrix of differences comprises:
determining that the storage device will not fail when the first similarity is greater than the second similarity; and
determining that the storage device will fail when the first similarity is not greater than the second similarity.

5. The method of claim 3, wherein the first similarity is indicative of a sum of distances between the matrix of differences and the first matrices of differences, and the second similarity is indicative of a sum of distances between the matrix of differences and the second matrices of differences.

6. The method of claim 5 further comprises:
determining first distances between the matrix of differences and the first matrices of differences based on a matrix of first weights for the attributes, the matrix of differences, and the first matrices of differences; and
determining second distances between the matrix of differences and the second matrices of differences for the plurality of failed storage devices based on a matrix of second weights for the attributes, the matrix of differences and the second matrices of differences.

7. The method of claim 6,
wherein the determining of the first distances comprises:
using a product of a difference between each element of the matrix of differences and a corresponding element of the first matrix of differences and a weight element corresponding to each element in the matrix of first weights as a healthy weight difference corresponding to each element of the matrix of differences; and
obtaining an arithmetic square root of the healthy weight difference corresponding to elements of the matrix of differences as a distance between the matrix of differences and the first matrix of differences for each healthy storage device,
wherein the determining of the second distances comprises:
using a product of a difference between each element of the matrix of differences and a corresponding element of the second matrix of differences and a weight element corresponding to each element in the matrix of second weights as a failure weight difference corresponding to each element of the matrix of differences; and
obtaining an arithmetic square root of the failure weight differences corresponding to elements of the matrix of differences as a distance between the matrix of differences and the second matrix of differences for each failed storage device.

8. The method of claim 2, wherein the second similarity comprises: a third similarity between the matrix of differences and matrices of differences for a plurality of failed storage devices having a first predetermined type of failure, and a fourth similarity between the matrix of differences and matrices of differences for a plurality of failed storage devices having a second predetermined type of failure.

9. The method of claim 8, wherein the predicting of whether the storage device will fail based on the first similarity and the second similarity comprises:
determining a minimum value of the first similarity, the third similarity, and the fourth similarity;
determining that the storage device will not fail when the minimum value is the first similarity;
determining that the storage device will fail with the first predetermined type of failure when the minimum value is the third similarity; and
determining that the storage device will fail with the second predetermined type of failure when the minimum value is the fourth similarity.

10. The method of claim 2, wherein the predicting of whether the storage device will fail based on the first similarity and the second similarity comprises:
determining that the storage device will not fail when the first similarity is greater than the second similarity and greater than a first threshold;
determining that the storage device will fail with a first predetermined type of failure when the first similarity is greater than the second similarity and not greater than a first threshold;
determining that the storage device will fail with a second predetermined type of failure when the first similarity is not greater than the second similarity and is greater than a second threshold; and
determining that the storage device will fail with a third predetermined type of failure when the first similarity is not greater than the second similarity and is not greater than the second threshold.

11. The method of claim 9, the method further comprises: when determining that the storage device will fail with the second predetermined type of failure, analyzing the second predetermined type of failure based on at least one of:
determining that the storage device will not fail when a similarity between the matrix of differences for the storage device and matrices of differences for other storage devices is less than a third threshold; and
determining that the storage device will not fail when at least one of a temporal aggregation or a spatial aggregation of the second predetermined type of failures is present for a plurality of storage devices.

12. The method of claim 6, wherein the predicted values of the plurality of attributes for the first time period are determined based on actual values of the plurality of attributes of the storage device for a second time period by using a model, wherein the matrix of first weights and the matrix of second weights are determined during a training phase of the model.

13. A device for predicting a failure of a storage device, comprising:
a first logic circuit configured to determine a matrix of differences between actual values of a plurality of attributes of the storage device obtained during a first time period and predicted values of the plurality of attributes of the storage device for the first time period; and
a second logic circuit configured to predict whether the storage device will fail based on the matrix of differences.

14. The device of claim 13, wherein the second logic circuit is configured to predict whether the storage device will fail based on a first similarity between the matrix of differences and first matrices of differences for a plurality of healthy storage devices and a second similarity between the matrix of differences and second matrices of differences for a plurality of failed storage devices.

15. The device of claim 14,
wherein the first matrices of differences comprises a first matrix of differences between actual values of the plurality of attributes of each of the healthy storage devices obtained during a time period with a first duration and predicted values of the plurality of attributes of each of the healthy storage devices for the time period with the first duration,
wherein the second matrices of differences comprises a second matrix of differences between actual values of the plurality of attributes of each of the failed storage devices for the time period with the first duration before each failed storage device failed and predicted values of the plurality of attributes of each of the failed storage devices for the time period with the first duration before each failed storage device failed, and
wherein the first duration is the same as a duration of the first time period.

16. The device of claim 14, wherein the second logic circuit is configured to:
determine that the storage device will not fail when the first similarity is greater than the second similarity; and
determine that the storage device will fail when the first similarity is not greater than the second similarity.

17. The device of claim 14, wherein the first similarity is indicative of a sum of distances between the matrix of differences and the first matrices of differences, and the second similarity is indicative of a sum of distances between the matrix of differences and the second matrices of differences.

18. The device of claim 17, wherein the second logic circuit is configured to:
determine first distances between the matrix of differences and the first matrices of differences based on a matrix of first weights for the attributes, the matrix of differences, and the first matrices of differences; and
determine second distances between the matrix of differences and the second matrices of differences based on a matrix of second weights for the attributes, the matrix of differences and the second matrices of differences.

19. The device of claim 18, wherein the second logic circuit is configured to:
use a product of a difference between each element of the matrix of differences and a corresponding element of the first matrix of differences and a weight element corresponding to each element in the matrix of first weights as a healthy weight difference corresponding to each element of the matrix of differences;
obtain an arithmetic square root of each healthy weight difference corresponding to elements of the matrix of differences as a distance between the matrix of differences and the first matrix of differences for each healthy storage device;
use a product of a difference between each element of the matrix of differences and a corresponding element of the second matrix of differences and a weight element corresponding to each element in the matrix of second weights as a failure weight difference corresponding to each element of the matrix of differences; and
obtain an arithmetic square root of each failure weight difference corresponding to elements of the matrix of differences as a distance between the matrix of differences and the second matrix of differences for each failed storage device.

20. The device of claim 14, wherein the second similarity comprises: a third similarity between the matrix of differences and matrices of differences for a plurality of failed storage devices having a first predetermined type of failure, and a fourth similarity between the matrix of differences and matrices of differences for a plurality of failed storage devices having a second predetermined type of failure.

21. (canceled)

22. (canceled)

23. (canceled)

24. (canceled)
